(19) United States
(12) Patent Application Publication
(10) Pub. No.: US 2003/0108023 A1
(43) Pub. Date: Jun. 12, 2003

(54) Data transmission in a communication system

(76) Inventors: Gerald Lehmann, Berlin (DE); Bernhard Raaf, Munich (DE); Volker Sommer, Berlin (DE)

Correspondence Address: BELL, BOYD & LLOYD, LLC, P. O. BOX 1135, CHICAGO, IL, 60690-1135, US

(21) Appl. No.: 10/148,823

(22) PCT Filed: Dec. 1, 2000
(86) PCT No.: PCT/DE00/04288

(51) Int. Cl. H04B 7/216

(52) U.S. Cl. 370/342; 370/441

(57) ABSTRACT

The invention relates to a method for transmitting data bits (B) in a communications system. Said bits are allocated to a communications connection and are present in a sequential manner. Transmission channels (Chi) which have been separated according to a CDMA method are provided in the communications system. An individual spread code (SCi) is allocated to said channels respectively. The inventive method comprises the following steps: C≧2 of the transmission channels (Chi) are allocated to the communications connection. Consecutive bits (B) are combined to form bit groups (BG), whereby each group is provided with at least one bit and M bits at the most. Several bit groups (BG) are allocated to each transmission channel (CHi) in such a way that bit groups that were adjacent before allocation are allocated to different transmission channels after the allocation. M≧1 consecutive bits (B) of the bit groups (BG) allocated thereto are combined to form symbols (SY) for each transmission channel (CHi). The symbols (SY) are spread by means of the spread code (SCi) of the respective channel and the spread symbols (SYS) are sent.

In a CDMA (Code Division Multiple Access) mobile communications system, the available transmission capacity is divided by means of spread codes. This division enables separation of the subscribers and provides each subscriber with a portion of the capacity, i.e. a physical channel. The capacity of a physical channel is usually dimensioned in such a way that an adequate transmission speed is provided for a standard service, such as a voice service for example. If however a higher transmission speed is required for a subscriber, it is possible to make several physical channels available to this subscriber. This can be achieved by allocating a plurality of spread codes for the subscriber.

For the purposes of error protection on the transmission link, the data streams to be distributed over the physical channels can be encoded (FEC=forward error correction) and time-interleaved (interleaving). Interleaving has the effect that expected burst errors caused by interference on the transmission link are evenly distributed time-wise following de-interleaving at the receiving end in order to avoid burst errors at the input of the decoder for error correction.

The distribution of the time-interleaved data to be transmitted over several codes can cause the time interval gained by interleaving between originally adjacent (prior to interleaving) data bits to be reduced again during the transmission because transmission takes place concurrently in the individual channels.

For example it is possible to distribute the bits over the different channels in such a way that the first N bits are allocated to the first CDMA channel, the next N bits to the second channel, etc., where N is the capacity of each physical channel. This can lead to the above-described reduction of the time interval of the data to be transmitted which was the actual purpose of the interleaving, i.e. in some circumstances the previously performed time interleaving is partially compensated or reversed by division between several CDMA channels.

A method for transmitting data bits in a DS (direct sequence) CDMA mobile communications system is described in Adachi et al. “Coherent Multicode DS-CDMA Mobile Radio Access”, in IEICE Transactions on Communications, Volume E79B, Sep. 1, 1996, pages 1316-1324. In said system a plurality of transmission channels to which an individual spread code is allocated in each case are allocated to a communications connection. The bits allocated to the individual spread code channels are converted by a modulator into symbols which are subsequently spread by means of the spread code of the respective channel. Other mobile communications systems in which a plurality of spread codes are likewise allocated to a communications connection may be found in WO 99/01994 A, EP 0,918,410 A, and Dohi et al.: “Experiments on Coherent Multicodes DS-CDMA”, in: IEICE Transactions on Communications, Volume E79B, No. 9, Sep. 1, 1996, pages 1326-1331. None of the aforementioned documents makes reference to a correlation between the number of the bits allocated to each spread code channel at a particular time and the number of bits combined to form a modulation symbol in each case.

The object of the invention is to disclose a method for transmitting data bits allocated to a communications connection which permits a flexible adaptation to any interleaving of the data bits to be performed.

This object is achieved by a method as claimed in claim 1. Advantageous further developments of the invention form the subject-matter of the dependent claims.

The method for transmitting data bits, which are allocated to a communications connection and are present in a sequential manner, in a communications system in which transmission channels separated using a CDMA method are available, to which channels an individual spread code is allocated in each case, provides for the following steps:

C 2 of the transmission channels are allocated to the communications connection;

in each case N 1 consecutive bits are combined to form bit groups;

a plurality of bit groups are allocated to each transmission channel in such a way that bit groups that were adjacent before allocation are allocated to different transmission channels after allocation;

in each case M 1 consecutive bits of the bit groups allocated thereto are combined to form symbols for each transmission channel, where M N;

the symbols are spread by means of the spread code of the respective channel;

and the spread symbols are transmitted.

By virtue of the method according to the invention, the bits or bit groups respectively can be arranged in a sequence for transmission over the CDMA channels, that is to say by means of different spread codes, which sequence can be adapted flexibly to the requirements of a desired interleaving algorithm. The high degree of flexibility stems from the allocation of the individual bit groups to the channels, and the restriction of the bits per bit group to a number, that is at most equal to the number of bits allocated to each symbol in a subsequent method step has the effect of achieving the minimum possible impact on the result of interleaving.

It is possible for in each case only one bit to be allocated to the symbols. It is furthermore possible for only one bit to be allocated to each bit group.

According to an advantageous further development of the invention, it is provided that

for the allocation of the bit groups to the transmission channels, the C first consecutive bit groups are allocated to one of the C transmission channels in each case

and the preceding method step is repeated with the next following bit groups in each case until all bit groups are allocated.

This further development has the following advantages:

There is only a relatively slight reduction of the time interval, resulting from any prior interleaving performed, between originally adjacent bits during the transmission by means of a plurality of CDMA channels.

The method is simple, efficient and independent of any previously employed interleaving method and of the number of spread codes or CDMA channels used for the transmission.

The invention is described in greater detail below with reference to the exemplary embodiments represented in the figures, in which:

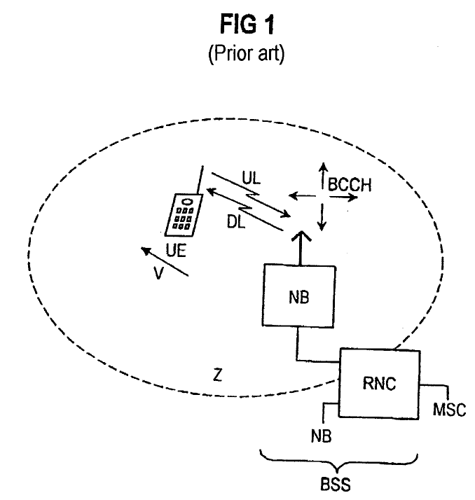

FIG. 1 shows a block circuit diagram of a radio communications system, in particular a mobile communications system,

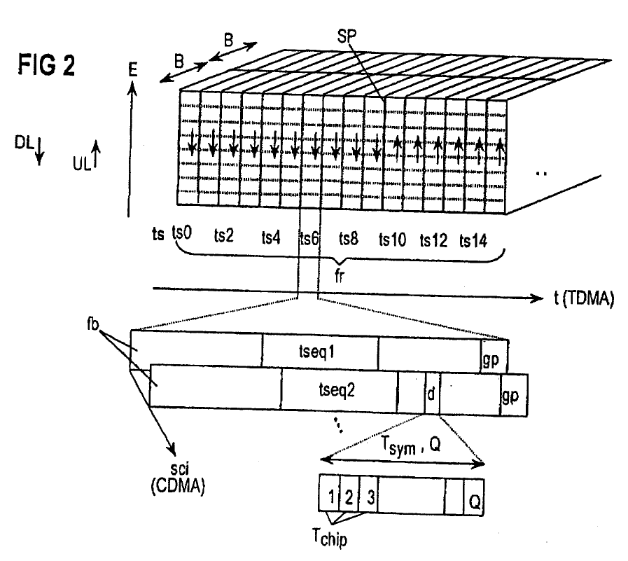

FIG. 2 shows an exemplary schematic representation of the frame structure of the radio interface and the structure of a radio burst,

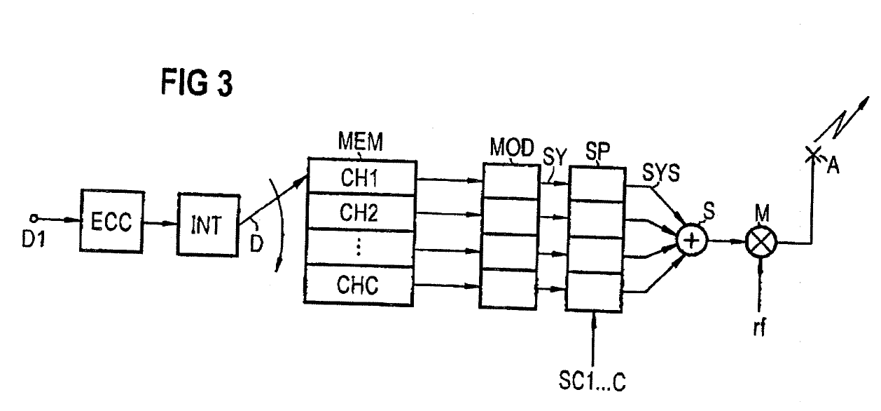

FIG. 3 shows a block circuit diagram of a transmission device, and

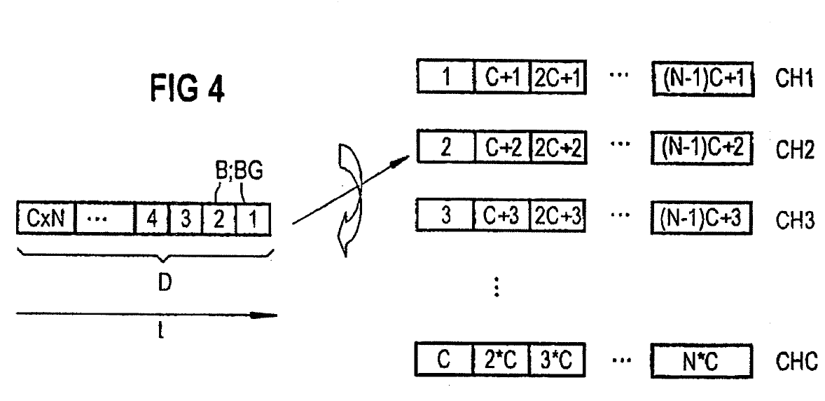

FIG. 4 shows the allocation of bit groups of a connection to a plurality of transmission channels.

FIG. 1 shows part of a mobile communications system as an example of the structure of a radio communications system. A mobile communications system is composed in each case of a plurality of mobile switching centers MSC which belong to a switching network (switching subsystem) and are internetworked or establish access to a fixed network PSTN respectively, and of in each case one or more base station systems BSS (base station subsystem) connected to said mobile switching centers MSC.

A base station system BSS has in turn at least one device RNC (radio network controller) for allocating radio resources and at least one base station NB (node B) connected thereto in each case.

A base station NB can establish and maintain connections to subscriber stations UE (user equipment) via a radio interface. At least one radio cell Z is formed by each base station NB. The size of the radio cell Z is usually determined by the range of a control channel (BCCH—broadcast control channel), which is transmitted from the base stations NB with an in each case higher and constant transmitter power. It is also possible to supply a plurality of radio cells Z for each base station NB in the case of sectorization or for hierarchical cell structures.

The example of FIG. 1 shows a subscriber station UE which is located in the radio cell Z of a base station NB and moves with a speed V. The subscriber station UE has established a communications connection to the base station NB, on which a signal transmission of a selected service takes place in the uplink direction UL and downlink direction DL. The communications connection is separated from communications connections concurrently established in the radio cell Z by one or more of the spread codes allocated to the subscriber station UE; the subscriber station UE uses for example all spread codes that are currently allocated in the radio cell Z in each case to receive the signals of its own communications connection in accordance with the known joint detection method.

FIG. 2 shows an exemplary frame structure of the radio interface as realized in the TDD mode of the future third generation mobile communications system UMTS (Universal Mobile Telecommunications System), and in modified form in the future Chinese TD-SCDMA mobile communications system. In accordance with a TDMA component, a broadband frequency band, for example the bandwidth B=5 MHz, is divided into a plurality of time slots ts, for example 16 time slots ts0 to ts15. Each time slot ts within the frequency band B forms one frequency channel. Within a broadband frequency band B, the successive time slots ts are arranged in with a frame structure. Thus 16 time slots ts0 to ts15 are combined to form a time frame fr. A plurality of successive time frames fr form a multiframe.

When a TDD transmission method is used, some of the time slots ts0 to ts15 in the uplink direction UL and some of the time slots ts0 to ts15 in the downlink direction DL are used, with the transmission in the uplink direction UL taking place before the transmission in the downlink direction DL for example. In between is a switching point SP which can be positioned flexibly depending on the respective demand for transmission channels for the uplink and downlink direction. The variable allocation of the time slots ts for the uplink or downlink direction UL, DL permits diverse asymmetric resource allocations.

Within the time slots ts information from a plurality of connections is transmitted in radio bursts fb. The data d is spread connection-specifically with a fine structure, a spread code SCi, so that at the receiving end a number of connections can be separated by this CDMA component (Code Division Multiple Access). A transmission channel is defined by the combination of a frequency channel and a spread code SCi, which transmission channel can be used for the transmission of signaling and user information. The spreading of individual symbols of the data d has the effect that Q chips of the duration T_{chip} are transmitted during the symbol duration T_{sym}. The Q chips form here the connection-specific spread code SCi. Also arranged in the radio bursts fb is a usually connection-specific training sequence tseq1 . . . which serves for a channel estimation at the receiving end. Furthermore, a protection time gp for compensating different signal propagation times of the connections of successive time slots ts is provided within the time slot ts.

The examples described below in illustration of the method according to the invention are not limited to the exemplary radio interface structure according to FIG. 2. The method can be advantageously realized analogously in the aforementioned Chinese TD-SCDMA (Time Division Synchronized Code Division Multiple Access) mobile communications system, in which the signal transmission is synchronized in the uplink direction UL, and the structure of the radio interface thereof differs in some respects from the TDD mode of the UMTS system described. It is also possible to employ the invention in FDD (Frequency Division Duplex) systems.

The method proposed here provides for a plurality of spread codes SCi to be allocated to a subscriber or communications connection in order to obtain a high data rate for a data service. For this purpose the data stream, directed in the downlink direction for example, of the connection must be divided between the transmission channels allocated to the spread codes.

FIG. 3 shows a general overview of the processing of bits to be transmitted of a digital data stream D1 in a subscriber station of the mobile communications system. Not shown in FIG. 3 are units which are also used in conventional transmission devices of mobile communications systems and which are therefore known to a person skilled in the art. The data D1 to be transmitted is encoded in an error coding unit ECC with an error correction code. It is then interleaved in an interleaver INT. At its output the interleaver INT supplies a data stream D with interleaved data bits which are fed to a memory unit MEM. The memory unit MEM is subdivided into C sub-areas which serve in each case to store a plurality of bits of the interleaved data stream D and are allocated to a CDMA channel CHi in each case. An individual spread code is allocated to each of the channels CHi. The allocation of the bits of the data stream D to the transmission channels CHi will be discussed further below with reference to FIG. 4.

The bits allocated to each channel CHi in the memory unit MEM are fed from there in parallel to further processing steps. First a modulation by modulators MOD takes place, which outputs at their outputs symbols SY into which they have combined a plurality of the bits in each case. The number of bits allocated to each symbol depends on the modulation method. In the case of QPSK (quaternary phase shift keying) for example, 2 bits are allocated to each symbol in each case.

The symbols SY are fed to spread units SP which spread the symbols by means of the spread code SCi associated with the respective channel CHi. The spread symbols are then overlaid by a summation S and modulated onto a high frequency carrier wave. Transmission via an antenna A then follows.

The allocation already mentioned with reference to FIG. 3 of the bits B of the interleaved data stream D to the CDMA transmission channels CHi will now be explained with reference to FIG. 4. The data stream D which is to be transmitted by the transmission device within a radio burst contains C×N bits B. The bits B were consecutively numbered in FIG. 4. The chronologically first bit of the data stream D has the number 1 etc.

The bits B of the data stream D are distributed over the channels CHi in such a way that the first bit 1 is allocated to the first channel CH1, the second bit 2 to the second channel CH2, etc. Once each channel CHi has been allocated one bit B in each case, allocation recommences with the first channel CH1 (bits C+1 to 2C) until all bits B have been distributed. There is thus a “bit-by-bit” division of the data stream D over the different channels CHi. The bits B are subsequently fed to the modulators MOD from FIG. 3 in the order shown on the right-hand side of FIG. 4. For the first channel CH1 this is for example the order 1, C+1, 2C+1, . . . , (n−1) C+1.

This method causes the bits B, which were arranged by the interleaver INT in the order of the data stream D shown in FIG. 4, to be transmitted virtually in this chronological order. Furthermore they are also transmitted simultaneously or directly one after another, since the data of all channels CHi is transmitted simultaneously in the form of radio bursts. As a result, the bits 1 to C are transmitted practically simultaneously, likewise the bits C+1 to 2C etc. The transmission of the bits 1 to C and those of bits C+1 to 2C is performed in very close temporal proximity. Consequently there is only minimal “compensation” of the effect of interleaving. The method described is independent of the interleaving performed beforehand. Thus the latter need not be adapted to the number of CDMA channels CHi used for the respective connection.

The same effect is also achieved if, instead of in each case 1 bit B as just described with reference to FIG. 4, in each case groups of a plurality of bits are allocated to one of the channels CHi at each allocation step. As a variation of the description of FIG. 4 just given, the elements consecutively numbered with 1 to C×N are then not individual bits B, but bit groups BG in which a plurality of bits B have been combined in each case. The same result as in the bit-by-bit allocation is achieved if the number of bits B per bit group BG does not exceed a value M, where M is the number of bits B allocated to each modulation symbol SY.

Furthermore, the capacity of the individual channels CHi can be different. In this case, allocation continues to be performed initially on a bit or bit group basis. As soon as the available capacity of a CDMA channel is exhausted, said channel is skipped for subsequent allocations.

The number of bits B per bit group BG can also be different here. This is especially advantageous if the spread codes SCi of the channels CHi to which the at least two bit groups BG are allocated have different spread factors Q. A large spread factor enables a greater number of spread codes to be differentiated. However, the transmission capacity of a channel that has a large spread factor is lower than that of a channel with a small spread factor. It is therefore favorable if the spread factors of the spread codes SCi of the channels CHi to which the at least two bit groups BG are allocated are inversely proportional to one another, like the number of bits B allocated to said groups. The allocation of the bit groups BG to the channels CHi with different capacity then leads to an even loading of said channels. Bit groups BG with relatively few bits B in each case are allocated to the channel with a lower capacity, and bit groups having relatively more bits in each case are allocated to the channel with a higher capacity.

Provided that the interleaving algorithm used by the interleaver INT supports it, the proposed method can also be performed in such a way that, prior to a modulation, the order of the bits allocated to them is reversed for a subset of the channels CHi, so that said bits are fed to the modulation in reverse order.

1. A method for transmitting data bits (B), which are allocated to a communications connection and are present in a sequential manner, in a communications system in which transmission channels (CHi) separated using a CDMA method are available, to which channels an individual spread code (SCi) is allocated in each case, having the following steps:
C 2 of the transmission channels (CHi) are allocated to the communications connection,
in each case N 1 consecutive bits (B) are combined to form bit groups (BG),
a plurality of the bit groups (BG) are allocated to each transmission channel (CHi) in such a way that bit groups that were adjacent before allocation are allocated to different transmission channels after allocation,
in each case M 1 consecutive bits (B) of the bit groups (BG) allocated thereto are combined to form symbols (SY) for each transmission channel (CHi), where M N,
the symbols (SY) are spread by means of the spread code (SCi) of the respective channel,
and the spread symbols (SYS) are transmitted.

2. The method as claimed in claim 1, having the following further steps:
for the allocation of the bit groups (BG) to the transmission channels (CHi), the C first consecutive bit groups are allocated to one of the C transmission channels in each case,
and the preceding method step is repeated with the next following bit groups (BG) in each case until all bit groups are allocated.

3. The method as claimed in claim 2, in which, as soon as the available transmission capacity of one of the transmission channels (CHi) is exhausted, the allocation of the as yet unallocated bit groups (BG) to the remaining channels is continued omitting said transmission channel.

4. The method as claimed in one of the preceding claims, in which, following their spreading, the symbols (SY) are simultaneously transmitted in all the transmission channels (CHi) allocated to the connection.

5. The method as claimed in one of the preceding claims, in which the data bits (B) are arranged in an interleaved sequence prior to their combination to form the bit groups (BG).

6. The method as claimed in claim 5, in which the data bits (B) are subjected to error correction coding (ECC) prior to interleaving.

7. The method as claimed in one of the preceding claims, in which the same number of bits (B) is allocated to each bit group (BG).

8. The method as claimed in one of claims 1 to 6, in which a different number of bits (B) is allocated to at least two of the bit groups (BG).

9. The method as claimed in claim 8, in which the spread codes (SCi) of the channels (CHi) to which the at least two bit groups (BG) are allocated have different spread factors (Q).

10. The method as claimed in claim 9, in which the spread factors of the spread codes (SCi) of the channels (CHi) to which the at least two bit groups (BG) are allocated are inversely proportional to one another, like the number of bits (B) allocated to said groups.

11. The application of the method as claimed in one of the preceding claims to a mobile communications system.
